(19) United States
(12) Patent Application Publication
(10) Pub. No.: US 2004/0059631 A1
(43) Pub. Date: Mar. 25, 2004

(54) Apparatus and method for determining data, apparatus, system, method and program for processing advertisement data, and recording medium in which the program is recorded

(75) Inventor: Kouji Amano, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignees: PIONEER CORPORATION, Tokyo (JP); INCREMENT P CORPORATION, Tokyo (JP)

(21) Appl. No.: 10/665,211

(22) Filed: Sep. 22, 2003

(30) Foreign Application Priority Data
Sep. 20, 2002 (JP) 2002-274922

(51) Int. Cl. G06F 17/60

(52) U.S. Cl. 705/14

(57) ABSTRACT

The invention provides an advertisement-data processing system that can easily give advertisement data a customer wants. The system comprises a network (200), a customer terminal (300), a shop terminal (400), and a server apparatus (500). The server apparatus (500) has a customer data storage section that stores customer data representing the size of the customer' family, the ages of family members, customer's address, the place to which the advertisement data should be sent. The shop terminal (400) has a POS register, which generates transaction content data in accordance with transaction data representing the items transacted (goods and service) and charges for the items transacted. The server apparatus (500) acquires the transaction content data via the network (200), predicts the items the customer may transact, in accordance with the family data and the transaction content data, selects advertisement data items for the customer, and transmits the advertisement data items to the customer terminal (300) via the network (200).

### BACKGROUND OF THE INVENTION

1. Field of the Invention

The present invention relates to an apparatus and method for determining data concerning transactions made by a customer. The invention also relates to an apparatus, system, method and program for processing advertisement data concerning the transactions made by the customer. Further, the invention relates to a recording medium in which the program is recorded.

2. Description of the Related Art

Hitherto, retail shops acquire customer data in the form of the questionnaires and membership-registration forms, all filled in by the customers. Each shop manages the data thus acquired and uses it to distribute, for example, advertisement data to the customers. Being personal information, the data about the customers is hard to obtain with ease and efficiency.

From the viewpoint of commercial transactions it is very important for retail shop managers to know what kind of service and goods their customers want. One customer wants a kind of service and goods, and another customer wants a different kind of service and goods. Further, the service and goods each customer wants depend on the current fashion or popularity. Hence, it is difficult for the shop managers to obtain, with ease and efficiency, data indicating what kind of service and goods the customers want.

A system is known wherein shops send advertisement data to customers via a communications network, such as the Internet and telephone line. In the system, the advertisement data items are stored in a server and sent to these data items to the shops' customers via the network, either automatically or at the customers' request. The advertisement data items are numerous and different one from another. The customers need different advertisement data items, depending on at which shops they want to get goods. Hence, the data items sent from the server to each customer indeed include some data items that the customer wants to receive. However, most of them are unnecessary to him or her. In view of this, some shops hesitate to use the system.

### SUMMARY OF THE INVENTION

An object of the present invention is to provide an apparatus and method for determining data, which renders it easy for shops to acquire data about customers with high efficiency. Another object of the invention is to provide an apparatus and method for determining data, which makes it easy for customers to acquire data about transactions that they want to make with shops. Still another object of the present invention is to provide an apparatus, system, method and program for easily sending to customers the advertisement data they want to receive. Another object of the invention is to provide a recording medium in which the program is recorded.

A data-determining apparatus according to the present invention comprises: a transaction-data acquisition section which acquires transaction data containing transaction-item data representing the items transacted by a customer, quantity data representing the number of pieces of each item transacted and charge data representing the charge for the items transacted; a transaction-content calculating section which calculates the number of pieces of each item transacted, the types of the items transacted and charges for each item transacted, in accordance with the transaction data about the transactions that the customer has made in a predetermined period, and which generates total transaction-number data, total item-number data and total charge data; and a family-data determining section which determines family data about the customer's family, in accordance with the total transaction-number data, the total item-number data and the total charge data.

Another data-determining apparatus according to the invention comprises: a family-data acquisition section which acquires family data containing at least one of data items representing the size, total income and address of a customer's family, the ages of the family members and the family status of the customer; a transaction-data acquisition section which acquires transaction data containing transaction-item data representing the items transacted by the customer, quantity data representing the number of pieces of each item transacted and charge data representing the charge for the items transacted; and a transaction content data determining section which determines at least one of data items representing the items to be transacted by the customer, the number of pieces of each item to be transacted and the shop in which the items are to be transacted, in accordance with the family data and the transaction data.

A method according to the present invention determines transaction data concerning a customer, by using an operation section. The method comprises: acquiring transaction data containing transaction-item data representing the items transacted by a customer, quantity data representing the number of pieces of each item transacted and charge data representing the charge for the items transacted; calculating the number of pieces of each item transacted, the types of the items transacted and charges for each item transacted, in accordance with the transaction data about the transactions that the customer has made in a predetermined period, and generating total transaction-number data, total item-number data and total charge data; and determining family data about the customer's family, in accordance with the total transaction-number data, the total item-number data and the total charge data.

A method according to the present invention determines transaction data concerning a customer, by using an operation section. This method comprises: acquiring family data containing at least one of data items representing the size, total income and address of a customer's family, the ages of the family members and the family status of the customer; acquiring transaction data containing transaction-item data representing the items transacted by the customer, quantity data representing the number of pieces of each item transacted and charge data representing the charge for the items transacted; and determining at least one of data items representing the items to be transacted by the customer, the number of pieces of each item to be transacted and the shop in which the items are to be transacted, in accordance with the family data and the transaction data.

An apparatus for processing advertisement data, according to the invention, comprises: a family-data acquisition section which acquires family data concerning a customer's family; an advertisement data storage section which stores advertisement data concerning transactions made by the customer in a shop; a transaction-content calculating section which calculates the charges for items transacted by the customer in the shop in a predetermined period and which generates total charge data; and a control section which selects advertisement data items in accordance with the family data and the total charge data and sends the advertisement data items to the customer.

An apparatus for processing advertisement data, according to this invention, comprises: an advertisement data storage section which stores advertisement data concerning transactions made by the customer in a shop; a transaction-data acquisition section which acquires transaction data containing transaction-item data representing the items transacted by the customer, quantity data representing the number of pieces of each item transacted and charge data representing the charge for the items transacted; a transaction-content calculating section which calculates the number of pieces of each item transacted, the types of the items transacted and charges for each item transacted, in accordance with the transaction data about the transactions that the customer has made in a predetermined period, and which generates transaction-number data, item-number data and total charge data; a family-data determining section which generates family data about the customer's family, in accordance with the transaction-number data, the item-number data and the total charge data; and a control section which selects advertisement data items in accordance with the family data and at least one of the transaction-number data, the item-number data and the total charge data, and which sends the advertisement data items to the customer.

A system for processing advertisement data according to the invention, comprises: an advertisement-data processing apparatus as described above; and a customer terminal which is owned by a customer and connected to the advertisement-data processing apparatus to transmit and receive various data items to and from the advertisement-data processing apparatus.

According to the invention there is provided a method of processing advertisement data for sending various data items concerning transactions made by a customer, by using an operation section. The method comprises: acquiring family data about the customer's family and calculating the total charge for transactions that the customer has made in a shop in a predetermined period, thereby to generate total charge data; and selecting advertisement data items for the customer from the advertisement data stored in an advertisement data storage section, in accordance with the family data and the total charge data, and sending the advertisement data items to the customer.

According to this invention there is provided a method of processing advertisement data for sending various data items concerning the transactions made by a customer, by using an operation section. The method comprises: acquiring, for a predetermined period, transaction data containing transaction-item data representing the items transacted by the customer, quantity data representing the number of pieces of each item transacted and charge data representing the charge for the items transacted; calculating the number of pieces of each item transacted, the types of the items transacted and charges for each item transacted, in accordance with the transaction data about the transactions that the customer has made in a predetermined period, and generating transaction-number data, item-number data and total charge data; determining family data about the customer's family, in accordance with the transaction-number data, the item-number data and the total charge data; and selecting advertisement data items for the customer from an advertisement data storage section in accordance with the family data and at least one of the transaction-number data, the item-number data and the total charge data, and sending the advertisement data items to the customer.

According to the present invention, there is provided a data-determining program for causing an operation section to perform the above-described data-determining method.

According to the present invention, there is provided a recording medium recording a data-determining program as described above, which is readable by an operation section.

According to the present invention, there is provided a program for processing advertisement data, for causing an operation section to perform an advertisement-data processing method as described above.

According to the present invention, there is provided a recording medium recording an advertisement-data processing program as defined above, which can be read by an operation section.

### BRIEF DESCRIPTION OF THE DRAWINGS

FIG. 1 is a block diagram schematically illustrating an advertisement-data processing system according to an embodiment of the invention, said system includes an advertisement-data processing apparatus according to the invention;

FIG. 2 is a block diagram schematically showing a customer terminal according to said embodiment;

FIG. 3 is a block diagram schematically depicting a shop terminal according to said embodiment;

FIG. 4 is a block diagram schematically showing a server apparatus according to said embodiment;

FIG. 5 is a schematic diagram showing a data structure of an advertisement data storage section according to said embodiment;

FIG. 6 is a schematic diagram showing a data structure of the advertisement data storage section having a table structure to store a transaction type and a class code as a set of record, employed in said embodiment;

FIG. 7 is a schematic diagram showing a data structure of a customer data storage section having a table structure to store customer data items as a set of record, employed in said embodiment;

FIG. 8 is a schematic diagram showing a data structure of a customer data storage section having a table structure to store personal data items as a set of record, employed in said embodiment;

FIG. 9 is a schematic diagram illustrating a data structure of a transaction data storage section having a table structure to store transaction data items as a set of record, employed in said embodiment;

FIG. 10 is a schematic diagram depicting a data structure of a transaction data storage section having a table structure to store transaction data items as a set of record, employed in said embodiment;

FIG. 11 is a flowchart explaining how to transmit the advertisement data according to the embodiment; and

FIG. 12 is diagram illustrating a customer hierarchy used to select advertisement data items according to the present embodiment . . .

### DETAILED DESCRIPTION OF THE PREFERRED EMBODIMENTS

An embodiment of the present invention will be described with reference to the accompanying drawings.

[Configuration of Advertisement-Data Processing Apparatus]

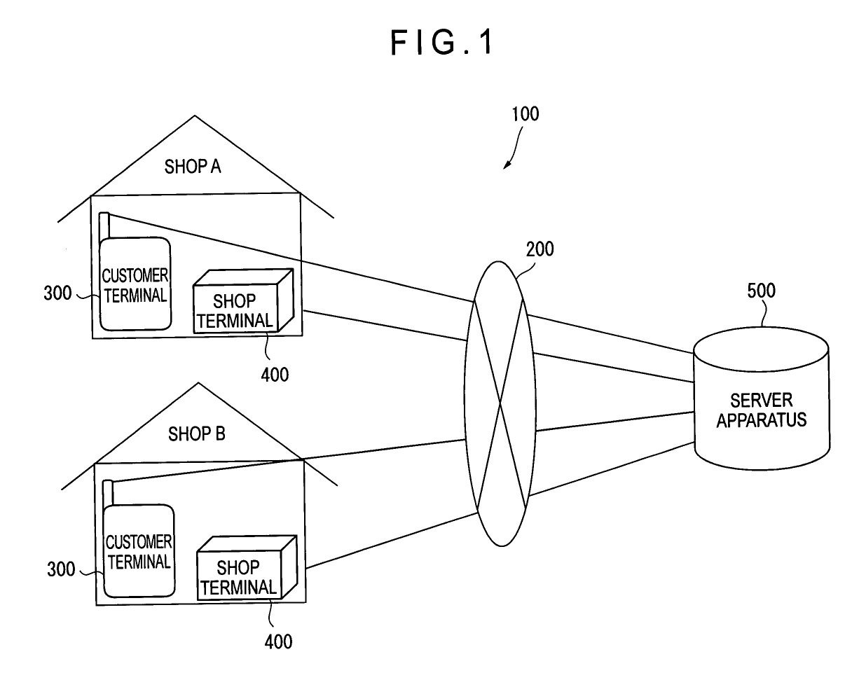

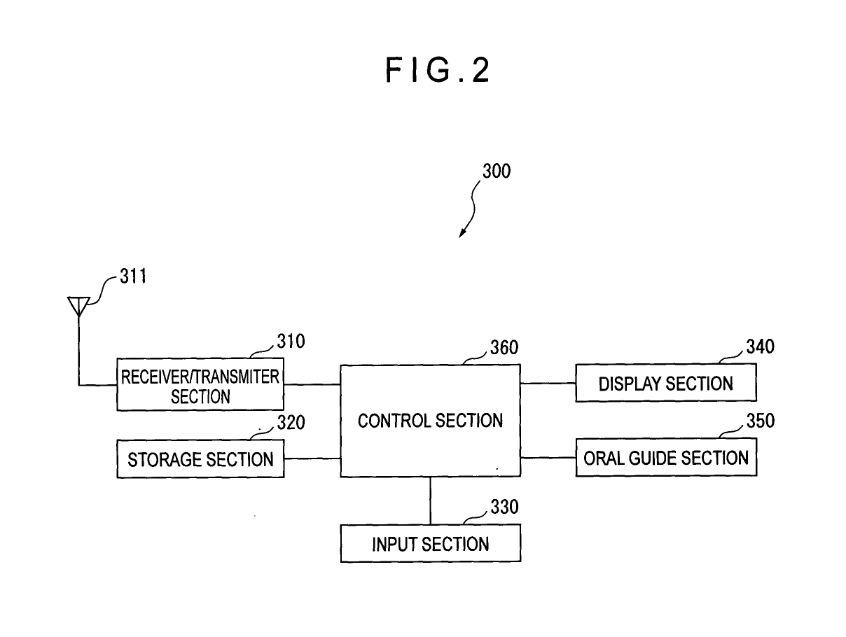

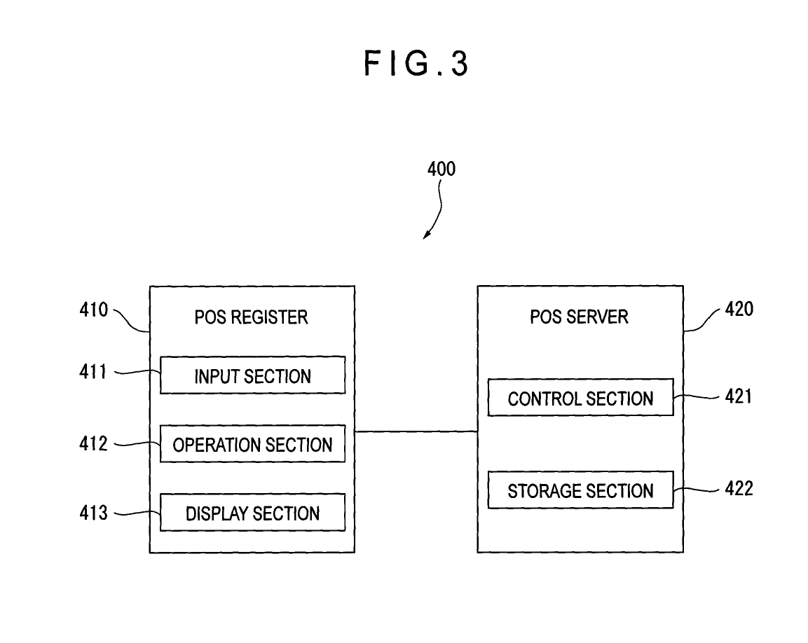

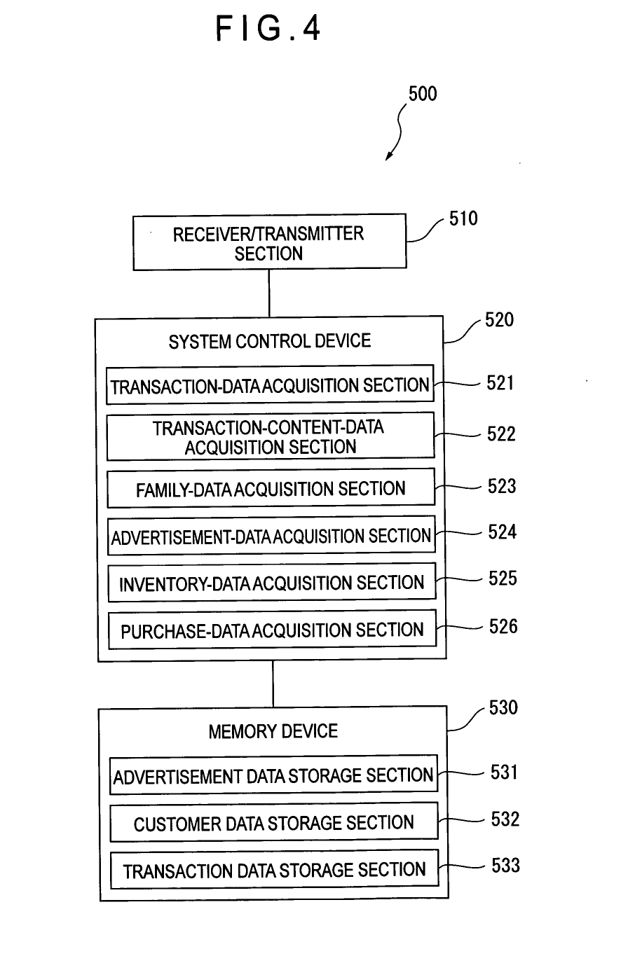

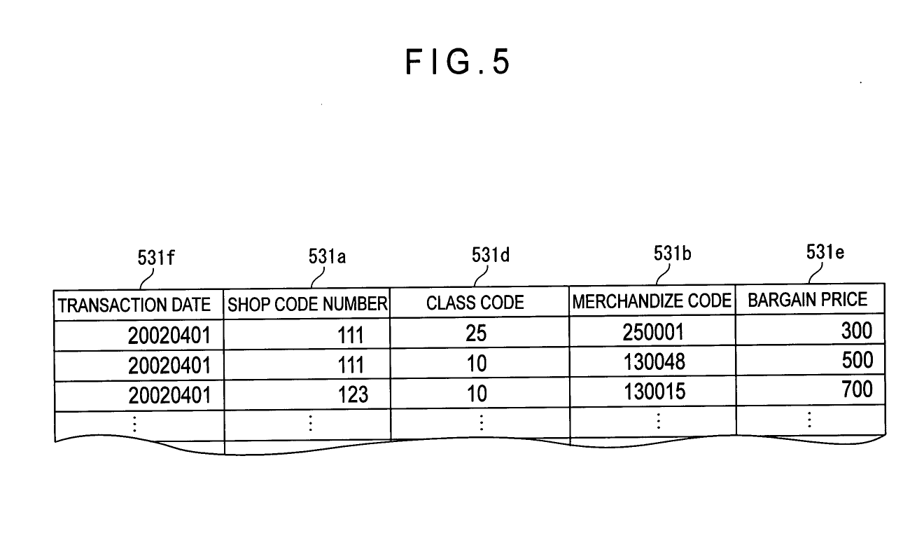

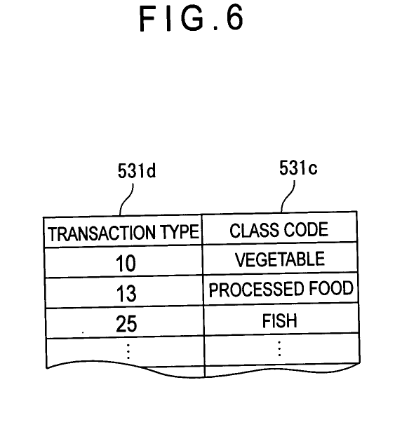

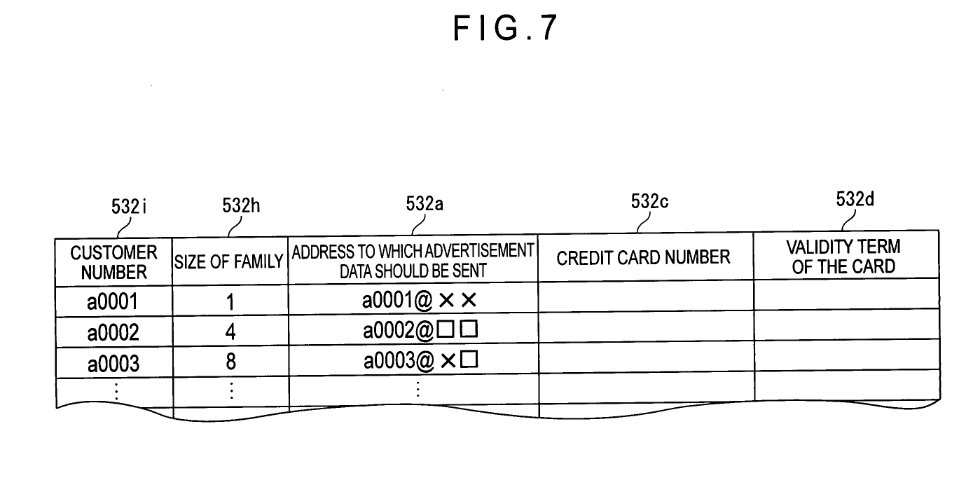

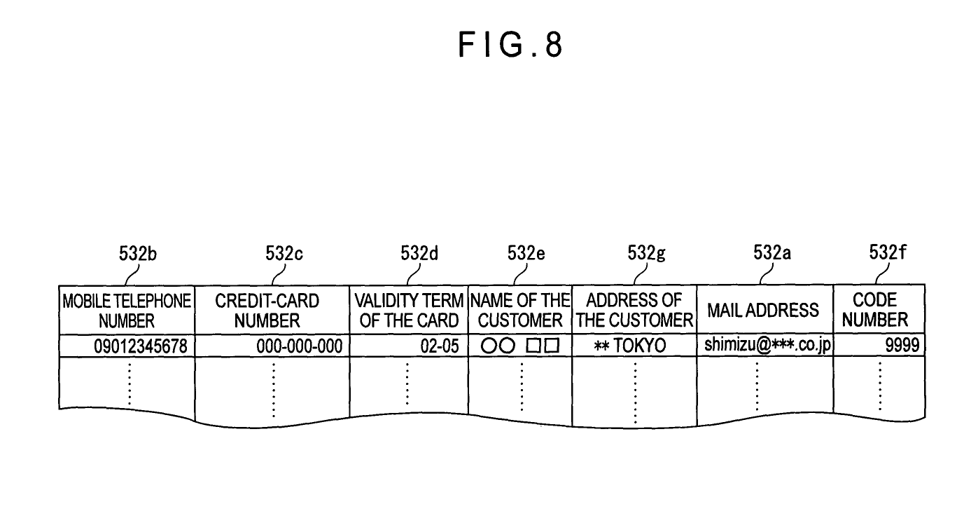

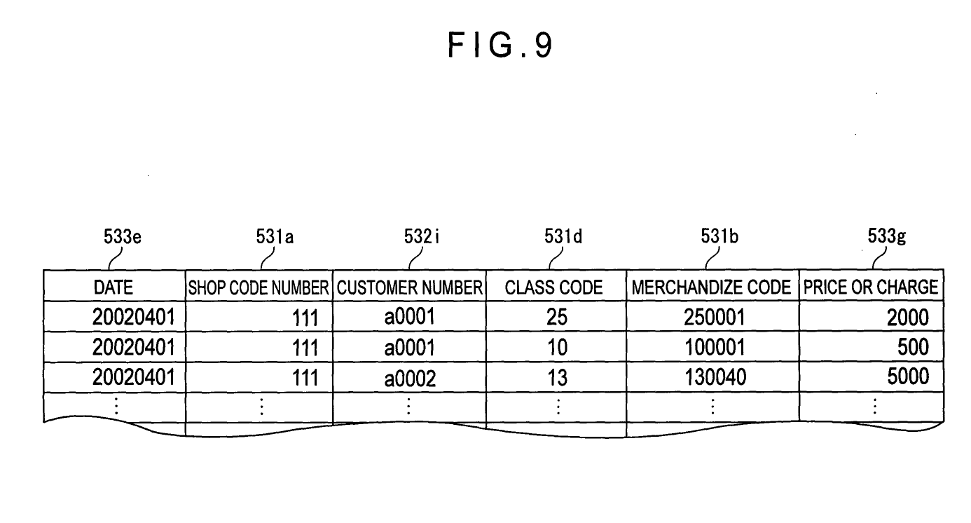

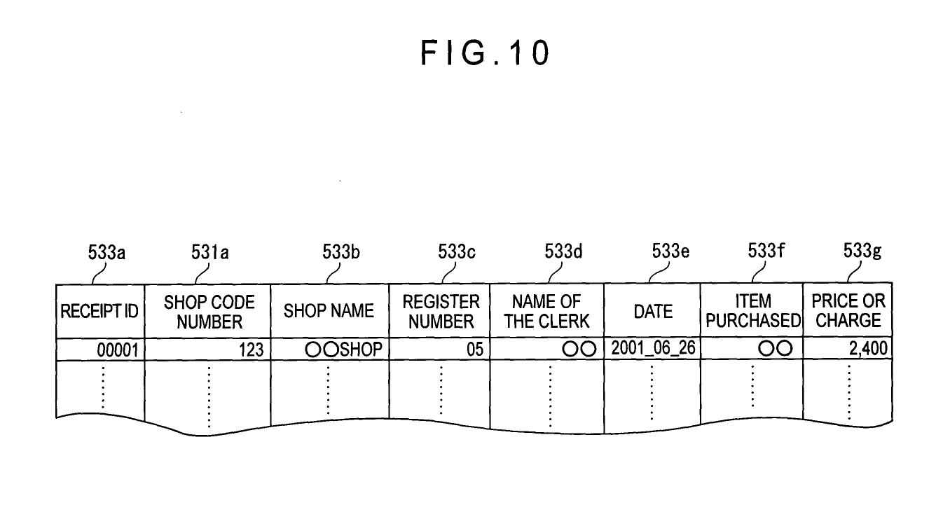

FIG. 1 is a block diagram illustrating an advertisement-data processing system according to one embodiment of the invention. The system includes an advertisement-data processing apparatus according to this invention. FIG. 2 is a block diagram schematically showing a customer terminal of the advertisement-date processing system. FIG. 3 is a block diagram schematically showing a shop terminal of the advertisement-date processing system. FIG. 4 is a block diagram schematically showing a server apparatus of the advertisement-date processing system. FIG. 5 is a schematic diagram that shows a data structure of advertisement data storage section having a table structure to store advertisement data items as a set of record. FIG. 6 is a schematic diagram that shows a data structure of the advertisement data storage section having a table structure to store a transaction type and a class code as a set of record. FIG. 7 is a schematic diagram that depicts a data structure of a customer data storage section having a table structure to store customer data items as a set of record. FIG. 8 is a diagram that shows a data structure of a customer data storage section having a table structure to store personal data items as a set of record. FIG. 9 is a diagram that illustrates a data structure of a transaction data storage section having a table structure to store transaction data items as a set of record. FIG. 10 is a diagram that depicts a data structure of a transaction data storage section having a table structure to store transaction data items as a set of record.

As may be seen from FIG. 1, the advertisement-data processing system 100 processes advertisement data that represents goods and service each shop can offer to customers. The system 100 comprises a network 200, customer terminals 300, shop terminals 400, and a server apparatus 500.

The network 200 is the Internet or the Intranet, each is based on a versatile protocol such as TCP/IP (Transmission Control Protocol/Internet Protocol). The customer terminals 300, the shop terminals 400, and the server apparatus 500 are connected to the network 200.

[Configuration of Customer Terminal]

The customer terminals 300 are mobile terminals, such as mobile telephones or PHSs (Personal Handyphone Systems). They can be general-purpose computers or mobile computers, each comprising an input device and a display and being able to transmit and receive data. A browser software or an E-mail software is installed in each customer terminal 300. User of the terminal 300 (i.e., customer) can therefore read homepages of various shops transmitted from base stations (not shown) via telephone lines. The homepage of each shop contains advertisement data. As illustrated in FIG. 2, each customer terminal 300 comprises a receiver/transmitter section 310, a storage section 320, an input section 330, a display section 340, an oral guide section 350, and a control section 360. The control section 360 is the main section of a computer.

The receiver/transmitter section 310 has an antenna 311 and can transmit signals to the network 200 and receive signals from the network 200. The section 310 is connected to the control section 360. It can therefore outputs the signals received from the network 200, to the control section 360, and outputs the signals received from the control section 360, to the network 200.

The storage section 320 can store the data output from the control section 360. The data stored in the section 320 can be read out. The section 320 is, for example, a RAM (Random Access Memory). Alternatively, it may be a disk drive that records data on a recording medium such as a hard disk, an optical disk or a magnetic disk.

The input section 330 is, for example, a keyboard. It has various buttons (not shown) for operating the customer terminal 300. More precisely, the input section 330 generates signals when buttons are pressed. The signals thus generated are output to the control section 360, setting operating conditions of the customer terminal 300. The operating conditions may be set by using a touch panel displayed by the display section 340. Alternatively, they may be set by means of a voice recognition device.

The display section 340 displays the data input from the control section 360, in the form of images, under the control of the control section 360. To be more specific, the display section 340 is a liquid crystal display, an organic EL (electroluminescence) display, a PDP (Plasma Display Panel), a CRT (Cathode-Ray Tube), or the like.

The oral guide section 350 has a voice-generating device (not shown) such as a speaker. It is controlled by the control section 360. It outputs the audio data contained in the data output from the control section 360 in the form of voice.

The control section 360 has various input/output ports (not shown). The ports include a data-receiving/transmitting port connected to the receiver/transmitter section 310, a storage section port connected to the storage section 320, a key-input port connected to the input section 330, a display control port connected to the display section 340, and an oral-guide control port connected to the oral guide section 350. The control section 360 is operated by a program that runs on the OS (Operating System) installed for controlling the customer terminal 300. Thus operated, the control section 260 processes the data received from the network 200 via the receiver/transmitter section 310 and the data to be transmitted to the network 200.

[Configuration of Shop Terminal]

The shop terminals 400 are POSs (Point-of-Sales) systems. As FIG. 3 shows, each shop terminal 400 comprises a POS register 410 and a POS server 420. The POS register 410 compiles the data items input to it and representing the items a customer has bought and the price of each item. It generates transaction data including the amount that the customer should pay for the items and services he or she has bought and received. The POS register 410 comprises, for example, an input section 411, an operation section 412, and a display section 413. The operation section 412 operates in accordance with a control program that runs on the OS (Operating System) installed in the shop terminal 400 to control the POS register 410. The operation section 412 receives the transaction data items input to the input section 411. The transaction data items represent the items transacted in that shop (i.e., the goods and services, sold and offered in the shop). The section 412 generates transaction data that represents the items transacted, the prices of goods, the charges for the services, the number of pieces each time transacted, the total mount to receive, and the like. The display section 413 displays the transaction data. The transaction data generated in the POS register 410 is output to the POS server 420.

The POS server 420 comprises a terminal control section 421 and a storage section 422. The terminal control section 421 entirely controls the shop terminal 400. The storage section 422 stores the transmitted and received data items. The shop terminal 400 may have two or more POS register 410. In this case, the POS server 420 receives transaction data items from the POS registers 410. In the POS server 420, the transaction data is stored into the storage section 422. The POS server 420 is connected to the Internet or the Intranet and can receive and transmit data from and to the Internet or the Intranet. The POS server 420 also stores auxiliary data items including the transaction date, the data about the shop and the data about the POS register or registers 410 used.

In the POS server 420, the terminal control section 421 can acquire data representing inventory of the shop. The inventory data thus acquired is stored into the storage section 422. Hence, the inventory of the shop can be known in the shop terminal 400. In the POS server 420, purchase data is generated from the transaction data generated by the operation section 412. Recall that the transaction data represents the items transacted, the prices of goods, the charges for the services, the number of pieces of each item transacted, the total amount to receive, and the like. The purchase data is stored into the storage section 422.

[Configuration of Server Apparatus]

The server apparatus 500 is a WWW (World Wide Web) server that is connected to the network 200. As illustrated in FIG. 4, the server apparatus 500 comprises a receiver/transmitter section 510, a system control device 520, and a memory device 530. The receiver/transmitter section 510 is a notification section. The system control device 520 is an operation section.

The receiver/transmitter section 510 receives signals from the network 200 and transmits signals to the network 200. The section 510 is connected to the system control device 520. The section 510 supplies the signals it has received from the network 200, to the system control device 520. The section 510 transmits the signals it has received from the system control device 520 to the network 200.

The system control device 520 executes various programs. It therefore processes the data items it has received from the network 200 via the receiver/transmitter section 510 and the data items to be transmitted to the network 200 via the receiver/transmitter section 510. The system control device 520 comprises a transaction-data acquisition section 521, a transaction-content-data acquisition section 522, a family-data acquisition section 523, an advertisement-data acquisition section 524, an inventory-data acquisition section 525, and a purchase-data acquisition section 526. The transaction-data acquisition section 521 is a program that runs on the OS. The transaction-content-data acquisition section 522 functions as a section for determining transaction data, too. The family-data acquisition section 523 functions as a section for determining family data. The system control device 520 is connected to the memory device 530. The data items acquired in the system control device 520 are output to and stored into the memory device 530. The memory device 530 stores any data acquired in the system control device 520. The data stored in the memory device 530 can be transmitted, as needed, to the network 200 via the system control device 520 and the receiver/transmitter section 510.

In the system control device 520, the transaction-data acquisition section 521 acquires the transaction data that the receiver/transmitter section 510 has received from any shop terminal 400 via the network 200. The transaction data thus acquired is output to the memory device 530.

Also in the system control device 520, the transaction-content-data acquisition section 522 acquires the transaction content data that the receiver/transmitter section 510 has received from any shop terminal 400 via the network 200. The transaction content data thus acquired is output to the memory device 530. The transaction-content-data acquisition section 522 functions as a transaction-content calculating section. Like the operation section 412 of the POS registers 410, the section 522 generates transaction content data such as, the total transaction-number data, the total item-number data, the total charge data, and the like, by calculating the number of transactions, the number of pieces of each item transacted, the total charges each item transacted, and the like.

In the system control device 520, the family-data acquisition section 523 acquires the family data that the receiver/transmitter section 510 has received from any customer terminal 300 or any shop terminal 400 via the network 200. The family data is information about a customer's family. The family data includes the family size, the income of the family, the residential area of the family, the age of each family member, the family status of the customer, and any combination of these data items. The family data thus acquired is output to the memory device 530.

The family-data acquisition section 523 functions as a family-data determining section that determines and acquires the family data in accordance with the transaction content data acquired by the transaction-content-data acquisition section 522. In this case, the family-data acquisition section 523 acquires the family data obtained at the time the customer registered himself or herself as a user of the advertisement-data processing system 100. The section 523 then acquires the family data from the transaction content data, as well as the family data. If the family data acquired represents the family size, it is generated from another family data item such as the average age of the family.

Also in the system control device 520, the advertisement-data acquisition section 524 acquires the advertisement data that the receiver/transmitter section 510 has received from the shop terminal 400 via the network 200. The advertisement data thus acquired is output to the memory device 530. The advertisement-data acquisition section 524 selects and acquires any advertisement data item from the memory device 530. The advertisement data item acquired from the memory device 530 is supplied to the receiver/transmitter section 510. The section 510 transmits the advertisement data item to the customer terminal 300 via the network 200. In other words, the receiver/transmitter section 510 and the advertisement-data acquisition section 524 constitute a control section according to the present invention. The advertisement-data acquisition section 524 may combine some of the data items stored in the memory device 530, such as key words, to generate an advertisement data item.

In the system control device 520, the inventory-data acquisition section 525 acquires the inventory data that the receiver/transmitter section 510 has received from the POS server 420 via the network 200. The inventory data thus acquired is output, as needed, and is stored into the memory device 530.

In the system control device 520, the purchase-data acquisition section 526 acquires the purchase data that the receiver/transmitter section 510 has received from the POS server 420 via the network 200. The purchase data thus acquired is stored into the memory device 530 whenever necessary. The purchase-data acquisition section 526 performs another function. It generates purchase data for the shop. More precisely, it generates the purchase data from the transaction content data acquired by the transaction-content-data acquisition section 522 and the inventory data acquired by the inventory-data acquisition section 525.

The memory device 530 has, for example, a hard disk, an optical disk or a magnetic disk. It records the data output from the system control device 520, thus storing the data. The memory device 530 comprises advertisement data storage section 531, customer data storage section 532, and transaction data storage section 533.

The advertisement data storage section 531 of the memory device 530 is a database having a table structure to store a plurality of records concerning advertisement. As FIG. 5 shows, each record consists of various advertisement data items. The advertisement data items are shop code number 531a, merchandise code 531b, transaction type 531c (also shown in FIG. 6), class code 531d (i.e., merchandize-classification code), a bargain price 531e, and the like. The shop code number 531a specifies name and shop of predetermined shops. The merchandize code 531b specifies the items sold at the bargain sale of the shop.

Each advertisement record may contain, in addition to the shop code number 531a, an auxiliary data item about the shop, such as the type, location, characteristic of the shop or the date of the bargain sale to be held at the shop (i.e., date 531f shown in FIG. 5). The advertisement data storage section 531 stores the auxiliary data item in association with the advertisement data items mentioned above.

The customer data storage section 532 of the memory device 530 stores, as needed, the customer data (i.e., personal information) and family data, both acquired by the family-data acquisition section 523. More specifically, the customer data storage section 532 is a database having a table structure to store a plurality of records concerning the customers and their families. As seen from FIGS. 7 and 8, each record consists of various customer data items. The customer data items are the mail address 532a of the customer terminal, the mobile telephone number 532b, the credit card number 532c, the validity term 532d of the credit card, the customer name 532e, the code number 532f, the ID (Identification) number (not shown), the customer's family status (not shown), the address 532g, the family size 532h, the total income of the family (not shown), the ages of the family members, and the like. Of these customer data items, the mail address 532a may be used to transmit the advertisement data from the server apparatus 500 to the customer terminal. As FIGS. 7 and 8 show, the customer's personal data and his or her family data may be stored as two records that are associated with each other.

The transaction data storage section 533 of the memory device 530 is a database having a table structure to store a plurality of records concerning transactions made at the shop. Each record consists of transaction data items printed on a receipt, as seen from FIGS. 9 and 10. The transaction data items are the receipt ID 533a, the shop code number 531a (associated with the advertisement data and identifying the shop), the name 533b of the shop, the number 533c of the POS register 410, the name 533d of the clerk at the register, the date and time 533e of the transaction, the code 533f of the item transacted (i.e., merchandize or service), the code number 531b of the item transacted, the class code 531d (i.e., type of the item transacted), the price or charge 533g of the item transacted, and the like. Each transaction record may be a combination of various data items concerning a transaction made in the shop. The data items include the total transaction-number data, the total item-number data, the total charge data, and the like. These data items may be stored in the form of independent records.

[Operation of the Advertisement-Data Processing System]

How the advertisement-data processing system 100 operates will be described, with reference to the drawings.

(Use of the Shop)

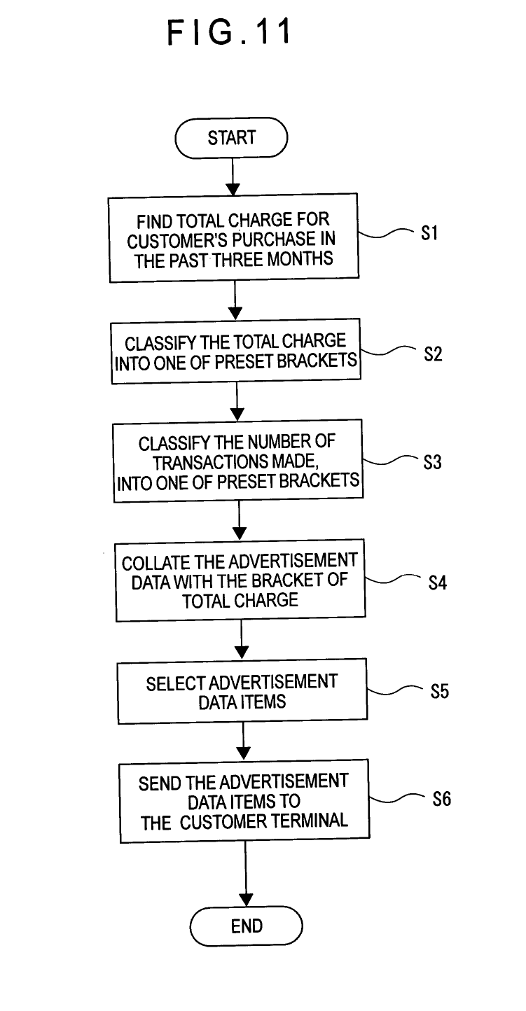

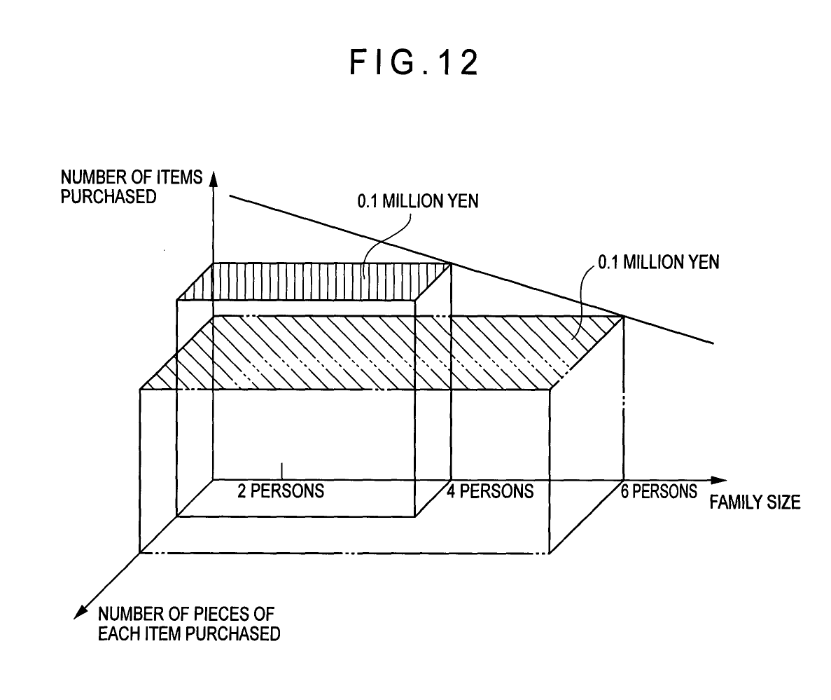

Assume that a customer wishes to obtain advertisement data in a shop that has a shop terminal 400 connected to the server apparatus 500 via the network 200. Also assume that the customer wants to make an on-line settlement in the shop, by using the credit card or his or her mobile telephone. FIG. 11 is a flowchart explaining how the customer makes the on-line settlement in the shop. FIG. 12 is a diagram that illustrates the customer hierarchy that is used to determine which advertisement data item can be sent to the customer.

First, the customer buys a piece of merchandize or receives a service in the shop. The account for the merchandize or service is settled at in the POS register 410 installed in the shop. That is, the clerk operates the input section 411 of the POS register 410. Thus, transaction data items are input, which include the type of merchandize or service the customer has bought or received, the amount or charge for the merchandize or service, and the like. In the POS register 410, the operation section 412 generates transaction content data from the transaction data items input at the input section 441. The transaction content data includes the number of all items transacted, the number of all pieces of items transacted, the total amount for the items transacted, and the like. The display section 413 of the POS register 410 displays the transaction content data, which the customer can read. At the same time, the transaction content data is stored into the storage section 422 of the POS server 420.

The POS register 410 is set in standby state so that the mode of settlement may be set. The mode can be settlement by cash, settlement by credit card or on-line settlement by the use of a mobile telephone. The clerk operates the input section 411 of the POS register 410, selecting one of these settlement modes. Then, the POS register 410 outputs various data items that are used to settle the account in the commercial transaction. The data items are transmitted from the shop terminal 400 to the server apparatus 500.

Assume that the settlement by cash has been selected. Then, the transaction data and the transaction content data, both stored in the storage section 422 of the POS server 420, are transmitted to the server apparatus 500, together with the shop data concerning the shop and a signal designating the settlement by cash. The transaction data, transaction content data, shop data and cash-settlement signal are associated with one another and constitute settlement data. The settlement data is supplied to the storage section 422 of the POS server 420 and stored therein.

The settlement by credit card may be selected at the input section 411. In this case, the data recorded in the credit card and the shop data are transmitted to the server apparatus 500, along with the transaction data and the transaction content data. The on-line settlement may be selected. If so, the customer operates the input section 411, inputting his or her ID data, such as code number, membership number or ID number. Alternatively, the customer may operates his or her terminal 300, supplying his or her ID data to the shop terminals 400 through the telephone line, by wireless transmission (using electric wave, light, infrared ray or Bluetooth), or through a cable connecting the terminal 300 to the shop terminal 400. The transaction data, transaction content data and ID data, and the shop data are transmitted, as settlement data, from the shop terminal 400 to the server apparatus 500 via the network 200.

In the server apparatus 500, the receiver/transmitter section 510 receives the settlement data transmitted from the shop terminal 400. The transaction-data acquisition section 521 and the transaction-content-data acquisition section 522, both incorporated in the system control device 520, acquire the settlement data. The system control device 520 outputs the settlement data, which is supplied to the memory device 530. In the memory device 530, the transaction data storage section 533 stores the settlement data.

The server apparatus 500 reads from the transaction data the total charge that the customer should pay for the transactions made in, for example, past three months, on the basis of the customer data and the date contained in the transaction data (Step S1). Alternatively, the transaction-content-data acquisition section 522 of the server apparatus 500 may calculate the total charge for the transactions the customer made in the past three months (Step S1). The system control device 520 of the server apparatus 500 classifies the total charge acquired in step S1 into one of the brackets, e.g., “0-0.1 million yen,” “0.1-05 million yen” and “0.5-1.0 million yen” stored in the memory device 530 (Step S2).

Then, the system control device 520 of the server apparatus 500 reads the data items about the customer from the customer data storage section 532, in accordance with a customer number assigned to the customer in Step S1. The device 520 classifies, for example, the family size, the number of items transacted and the number of pieces of each item transacted, each to one of preset brackets (Step S3). On the basis of the rank determined in Step S2 and the ranks determined in Step S3, the system control device 520 classifies the customer to a specific rank as is illustrated in FIG. 12.

Of the customers who belong to the same bracket of total charge, one having a small family and one having a large family differ in terms of the number of items transacted and/or the number of pieces of each item transacted. That is, a small family buys less goods of the same category than a large family. Since these families belong to the same bracket of total charge, the small family buys more expensive goods of that category than the large family. Of the customers who have the families of the same size, one having aged dependants buys goods for the old, while one having young dependents buys goods for children. Thus, the price and type of any good that each customer wish to buy depend on the size and average age of his or her family.

Thus, the system control device 520 classifies the customer into a bracket of total charge in Step S2, and into a bracket of number of transactions and number of pieces of each item transacted. From these brackets it is possible to predict what kinds of goods the customer tends to purchase. The customer may buy more goods of a specific type than the threshold value stored in the memory device 530. Hence, only a few advertisement data items need to be selected from many data items stored in the advertisement data storage section 531. To be more specific, the advertisement data stored in the storage section 531 are collated with the bracket of the total charge, determined in Step S2, and the number of pieces of each item transacted, determined in Step S3 (Step S4). Then, the advertisement data items associated with the bracket of total charge and the number of pieces of each item transacted is selected (Step S5).

The receiver/transmitter section 510 transmits the advertisement data items selected in Step S5 to the customer terminal 300 via the network 200 (Step S6). The display section 340 of the customer terminal 300 displays the advertisement data, which the customer reads.

In the server apparatus 500, the system control device 520 generates purchase data concerning the purchase of the items included in the advertisement data items selected in Step S5. That is, the device 520 generates the purchase data from the inventory data and the transaction data or the transaction content data, or both. The inventory data has been acquired by the inventory-data acquisition section 525 and represents the inventory at the shop. On the other hand, the transaction data and the transaction content data have been acquired to select the advertisement data items. The purchase data thus generated is transmitted, as needed, from the receiver/transmitter section 510 via the network 200 to the shop terminal 400 installed in the shop. In the shop terminal 400, the POS server 420 acquires the purchase data. In the POS server 420, the storage section 422 stores the purchase data. The manager of the shop purchases goods in accordance with the purchase data.

After transmitting the advertisement data, the server apparatus 500 acquires the transaction data again. The apparatus 500 determines whether the item represented by the transaction data is identical to the item represented by the advertisement data. If the customer has bought the item advertised, the conditions for selecting only a few of the advertisement data items (shown in the flowchart of FIG. 11) are maintained. If the customer has bought an item other than the advertised, this fact is counted. When the count exceeds a value stored in the memory device 530, the system control device 520 performs the process of changing the conditions for selecting a few advertisement data items. More precisely, the device 520 uses the average age of the customer's family, instead of the number of pieces of each item transacted, to classify the customer.

[Advantages of the Advertisement-Data Processing System]

In the advertisement-data processing system 100, the family-data acquisition section 523 acquires the family data concerning the customer's family. The transaction-content-data acquisition section 522 calculates the total charge that the customer should pay for the transactions he or she has made in a predetermined period. Based on the data and the total charge, only a few of the advertisement data items stored in the storage section 531 are selected. The advertisement data items selected are transmitted to the customer. Thus, only the advertisement data suitable for the customer is automatically transmitted to the customer. Therefore, the customer can easily decide which goods or which service should be bought or received for the family. In view of this, the system 100 is an efficient advertisement-distributing system and can be widely used.

In the server apparatus 500, the advertisement-data acquisition section 524 may select a few advertisement data items in accordance with the numbers of goods or services that the customer has transacted in a predetermined period. In this case, the transaction-data acquisition section 521 acquires the data representing the number of any good or service that the customer has transacted in that period. If the number acquired by the section 521 exceeds a prescribed threshold, the advertisement-data acquisition section 524 selects the advertisement data item about this good or service. Thus, the advertisement data items about the goods or services which are often transacted by the customer can be easily selected. Therefore, the advertisement data that the customer really needs can be distributed.

The system control device 520 generates purchase data concerning the purchase of the items included in the advertisement data items selected. Namely, the device 520 generates the purchase data from the inventory data and the transaction data or the transaction content data, or both. The inventory data has been acquired by the inventory-data acquisition section 525 and represents the inventory at the shop. The transaction data and the transaction content data have been acquired to select the advertisement data items. The purchase data thus generated is transmitted from the receiver/transmitter section 510 via the network 200 to the shop terminal 400 installed in the shop. From the purchase data the manager of the shop can easily know which items of goods advertised should be purchased into the shop and may purchase these items. Thus, the purchase data enables the manager to prevent shortage of goods and, hence, offer the customer the items specified in the advertisement data.

As mentioned earlier, the server apparatus 500 acquires the transaction data again after transmitting the advertisement data. The apparatus 500 then determines whether the item represented by the transaction data is identical to the item represented by the advertisement data. Thus, the apparatus 500 can easily determine whether a transaction has been actually made in connection with the items advertised. The server apparatus 500 may alter the conditions for selecting a few advertisement data items from many advertisement data items available. Hence, the apparatus 500 can select advertisement data items more suitable for the customer.

As specified above, the system control device 520 classifies the customer in terms of, for example, four conditions, i.e., the size of family, the total charge, the number of transactions made and the number of pieces of each item transacted. Thus, it is easy to predict what goods the customer may buy in the shop and how many pieces of each good he or she may want. Therefore, the apparatus 500 can reliably select advertisement data items that the customer really needs.

As described above, the shop terminal 400 acquires the transaction data and the transaction content data and transmits them to the server apparatus 500, which selects the family data and the advertisement data. The apparatus 500 can therefore use the transaction content data that the shop terminal 400 has generated in order to settle the account in the transaction. Since the apparatus 500 need not generate transaction content data, it can select advertisement data items with high efficiency. Moreover, the shop terminal 400 can manage the contents of transactions, without necessity of modifying the contents, and can therefore perform inventory control, purchase control and shop-operation control in accordance with the transaction data and the transaction content data, in the same manner as before. This encourages shops to utilize the advertisement-data processing system 100 in order to expand their sales.

The advertisement data is distributed in accordance with contact information such as mail addresses and mobile telephone numbers, all included in the customer data. Thus, the advertisement data can be transmitted to the customer, both automatically and easily.

As specified earlier, the advertisement-data processing system 100 comprises the customer terminals 300, the shop terminals 400 and the server apparatus 500. Connected to the terminals 300 and 400 by the network 200, the server apparatus 500 can not only easily manage the customer data, the transaction data, the transaction content data, the shop data, and the like. But also can the apparatus 500 easily distribute the advertisement data and the purchase data. The system 100 is therefore useful and can be put to widespread use.

[Modification of the Embodiment]

The present invention is not limited to the embodiment described above. Rather, the embodiment can be modified so long as the object of the invention can be attained.

In the embodiment described above, the server apparatus 500 acquires the transaction data and transaction content data from each shop terminal 400 and selects some advertisement data items in accordance with the transaction content data and the family data. Nonetheless, the server apparatus 500 may acquire only the transaction data from the shop terminal 400. And the transaction-content-data acquisition section 522 of the apparatus 500 may calculate and generate transaction content data from the transaction content. Alternatively, the transaction data and the transaction content data may be stored in the server apparatus 500, not in the shop terminal 400 as in the embodiment. Thus, the server apparatus 500 can select a few advertisement data items from many. The shop terminal 400 need not manage the transaction data or the transaction content data. Controlling both the transaction data and the transaction content data, the server apparatus 500 can easily distribute the advertisement data to the customer terminals even if the shop terminal 400 has no POS server 420. In other words, the shop terminals 400 do not require such a special device as the POS server 420, only if the server apparatus 500 acquires the transaction data and the transaction content data. This simplifies the advertisement-data processing system 100. The system 100 can then be utilized more widely.

In the embodiment, the server apparatus 500 selects some advertisement data items in accordance with the transaction content data and the family data. The server apparatus 500 may select the advertisement data in accordance with the family data and the transaction data, which contains data items representing the goods transacted, the number thereof, and the charge therefor. Assume that the transaction data shows that the customer has purchased a car and that the family data shows that the average age of the customer's family is low. Then, the advertisement-data acquisition section 524 determines that the customer will probably buy a child seat. The server apparatus 500 therefore selects the advertisement data concerning child seats and transmits this data. Further, the section 524 determines that the customer will probably take children to an amusement park. In this case, the server apparatus 500 selects the advertisement data on amusement parks and transmits this data. If the average age is high and size of the family is small, the section 524 determines that the customer will probably reserve rooms in an old-fashioned hotel with hot-spring facility, and the server apparatus 500 selects the advertisement data introducing such hotels.

The transaction data may show that the customer has purchased a good that would not be often bought or an article that is very expensive, and the family data available may be a relatively detailed one. In this case, the transaction-content-data acquisition section 522 need not calculate the total charge to be paid for the transactions made in a predetermined period. Hence, the data about the transactions made during that period need not be accumulated at all. Without the data showing the total charge or the data representing the transactions made during a specific period, the server apparatus 500 can select and distribute advertisement data items suitable for the customer.

The family data stored in the server apparatus 500 is used to select some advertisement data items in the embodiment described above. Instead, transaction content data that contains at least the number of transactions made, the number of pieces of each item transacted and the amount or charge for all items transacted may be generated from, for example, the transaction data. The system control device 520 uses the transaction content data thus generated, classifying the customer to a specific rank. Once the customer is so classified, the family data can then be obtained.

More specifically, if the transaction content data shows that candies have been frequently bought, it is determined that the family has children. Further, if the transaction content data indicates how many pieces of the same candy have been bought, the number of children can be estimated. If candies with a giveaway such as a figure of a character which is popular among young children are bought, the children are considered to be relatively young. If the transaction content data shows that diapers and powdered milk have been purchased, it is inferred that the family has an infant or infants. If the family had a dinner in a restaurant, the family size can be determined from the record kept at the restaurant. Thus, the family data can be obtained once the customer has been classified to a specific rank in accordance with various conditions such as the items transacted (e.g., candies), the types of items transacted and the number of identical items transacted.

Thus, the data about the customer's family can be obtained from the transaction content data. In accordance with the family data thus obtained, advertisement data items suitable for the customer can be selected and transmitted to the customer terminal 300. This renders the system 100 more versatile.

As specified above, the system control device 520 generates purchase data, which is transmitted to the shop terminal 400. Nevertheless, the server apparatus 500 may have no device that generates purchase data, and the shop terminal 400 may generate purchase data and manage the same.

The server apparatus 500 incorporated in the embodiment (i.e., system 100) may comprise only the transaction-data acquisition section 521, transaction-content-data acquisition section 522 and family-data acquisition section 523. The section 522 determines transaction content data from the transaction data the section 521 has acquired. The section 523 determines family data from the transaction content data. Comprising the sections 521, 522 and 523 only, the system 100 may be utilized as a data determining apparatus for determining family data. With such configuration, since family data can be easily determined based on commercial transactions, the system can be used for credit exposure management not for advertisement data distribution.

Furthermore, the transaction-content-data acquisition section 522 may obtain transaction content from the transaction data and family data acquired by the transaction-data acquisition section 521 and family-data acquisition section 523, respectively. In this case, the contents of each transaction made can be easily determined, not only to distribute advertisement data and also to conduct market researches for new products.

In the embodiment described above, the server apparatus 500 acquires various information, such as customer data, transaction data and transaction content data, from the customer terminals 300 and the shop terminals 400 via the network 200, or by means of so-called “on-line communication”. Nevertheless, the apparatus 500 may acquire the information from the postcards or telephone messages sent from the customers and shops to the manager of the advertisement-data processing system 100. The manager of the system 100 inputs the information thus sent, directly into the server apparatus 500. Further, the advertisement data and the purchase data may be sent from the server apparatus 500, not by the on-line communication but by sending, for example, postcards to the customers and shops.

In the above embodiment, the network 200 is used to transmit and receive information. The network 200 is not limited to the Internet. Rather, it may be, for example, a LAN (Local Area Network). If this is the case, LAN cables connect personal computers, which constitute the advertisement-data processing system 100.

As indicated above, the network 200 connects the shop terminals 400 to the server apparatus 500. Instead, the POS server 420 of each shop terminal 400 may incorporate the server apparatus 500. In this case, the POS server 420 can distribute advertisement data to the customer terminals 300.

The program that controls the operation section that is, for example, a computer, may be distributed in the market, either installed in an apparatus or recorded in a recording medium. If so distributed, utilization of the program can be promoted with the use of general-purpose computers. The operation section incorporated in the system 100 comprises one computer, a plurality of computers connected by a network, an electronic component such as a microcomputer, or a circuit board with electronic components mounted on it.

The structure of the embodiment of this invention and the sequence of operation of the embodiment can be changed or modified in whichever way, so long as the object of the invention can be achieved.

What is claimed is:

1. A data-determining apparatus comprising:
a transaction-data acquisition section which acquires transaction data containing transaction-item data representing items transacted by a customer, quantity data representing the number of pieces of each item transacted and charge data representing charge for the items transacted;
a transaction-content calculating section which calculates the number of pieces of each item transacted, the types of the items transacted and charges for each item transacted, from the transaction data about the transactions that the customer has made in a predetermined period, and which generates total transaction-number data, total item-number data and total charge data; and
a family-data determining section which determines family data about the customer's family, from the total transaction-number data, the total item-number data and the total charge data.

2. A data-determining apparatus according to claim 1, further comprising:
an advertisement data storage section which stores advertisement data items concerning transactions to be made by the customer in a shop; and
a control section which selects and sends advertisement data items to the customer, in accordance with the family data and the total charge data acquired by the family-data acquisition section.

3. A data-determining apparatus according to claim 1, further comprising a family-data acquisition section which acquires family data, and in which the family-data determining section determines family data different from the acquired family data by using the family data acquired by the family-data acquisition section.

4. A data-determining apparatus according to claim 1, further comprising a transaction-content-data determining section which determines at least one of data items representing the items transacted by the customer, the number of pieces of each item transacted and the shop in which the items are transacted, in accordance with the family data determined by the family-data determining section and the transaction data acquired by the transaction-data acquisition section.

5. A data-determining apparatus comprising:
a family-data acquisition section which acquires family data containing at least one of data items representing the size, total income and address of a customer's family, the ages of the family members and the family status of the customer;
a transaction-data acquisition section which acquires transaction data containing transaction-item data representing the items transacted by the customer, quantity data representing the number of pieces of each item transacted and charge data representing the charge for the items transacted; and
a transaction content data determining section which determines at least one of data items representing the items to be transacted by the customer, the number of pieces of each item to be transacted and the shop in which the items are to be transacted, in accordance with the family data and the transaction data.

6. A data-determining apparatus according to claim 4, further comprising:
an inventory-data acquisition section which acquires inventory data concerning items transacted in the shop; and
a purchase-data sending section which generates purchase data concerning items to be purchased into the shop, in accordance with the inventory data and the data items determined by the transaction content data determining section and representing the items to be transacted by the customer and the number of pieces of each item to be transacted, and which sends the purchase data to the shop.

7. A data-determining apparatus according to claim 5, further comprising:
an inventory-data acquisition section which acquires inventory data concerning items transacted in the shop; and
a purchase-data sending section which generates purchase data concerning items to be purchased into the shop, in accordance with the inventory data and the data items determined by the transaction content data determining section and representing the items to be transacted by the customer and the number of pieces of each item to be transacted, and which sends the purchase data to the shop.

8. A data-determining apparatus according to claim 6, wherein the purchase-data sending section distributes the purchase data in accordance with shop data contained in the transaction data.

9. A data-determining apparatus according to claim 7, wherein the purchase-data sending section distributes the purchase data in accordance with shop data contained in the transaction data.

10. A data-determining apparatus according to claim 4, in which the family data contains a data item representing contact information of the customer, and further comprising:
an advertisement data storage section which stores advertisement data concerning transactions to be made by the customer and generated from the data item which has been determined by the transaction content data determining section and which represents the items transacted by the customer; and
an advertisement-data sending section which sends the advertisement data to the customer in accordance with the data item representing the contact information.

11. A data-determining apparatus according to claim 5, in which the family data contains a data item representing the contact information, and further comprising:
an advertisement data storage section which stores advertisement data concerning transactions to be made by the customer and generated from the data item which has been determined by the transaction content data determining section and which represents the items transacted by the customer; and
an advertisement-data sending section which sends the advertisement data to the customer in accordance with the data item representing the contact information.

12. A method of determining transaction data concerning a customer, by using an operation section, said method comprising:
acquiring transaction data containing transaction-item data representing the items transacted by the customer, quantity data representing the number of pieces of each item transacted and charge data representing the charge for the items transacted;
calculating the number of pieces of each item transacted, the types of the items transacted and charges for each item transacted, from the transaction data about the transactions that the customer has made in a predetermined period, and generating total transaction-number data, total item-number data and total charge data; and
determining family data about the customer's family, in accordance with the total transaction-number data, the total item-number data and the total charge data.

13. A method of determining transaction data concerning a customer, by using an operation section, said method comprising:
acquiring family data containing at least one of data items representing the size, total income and address of a customer's family, the ages of the family members and the family status of the customer;
acquiring transaction data containing transaction-item data representing the items transacted by the customer, quantity data representing the number of pieces of each item transacted and charge data representing the charge for the items transacted; and
determining at least one of data items representing the items to be transacted by the customer, the number of pieces of each item to be transacted and the shop in which the items are to be transacted, in accordance with the acquired family data and the transaction data.

14. An apparatus for processing advertisement data, comprising:
a family-data acquisition section which acquires family data concerning a customer's family;
an advertisement data storage section which stores advertisement data concerning transactions made by the customer in a shop;
a transaction-content calculating section which calculates the charges for items transacted by the customer in the shop in a predetermined period and which generates total charge data; and
a control section which selects advertisement data items in accordance with the family data and the total charge data and sends the advertisement data items to the customer.

15. An apparatus according to claim 14, further comprising a transaction-data acquisition section which acquires transaction data containing a data item representing the items transacted by the customer, and in which
the advertisement data contains data items representing the items advertised, and
the control section calculates, in accordance with the transaction data, the number of pieces of each item transacted in the predetermined period and selects an advertisement data item about the item that has been transacted in a quantity greater than a preset value.

16. An apparatus according to claim 14, further comprising a transaction-data acquisition section which acquires transaction data containing transaction-item data representing the items transacted by the customer, quantity data representing the number of pieces of each item transacted and charge data representing the charge for the items transacted, and in which the control section determines at least of data items representing the items to be transacted by the customer, the number of pieces of each item to be transacted and the shop in which the items are to be transacted, in accordance with the family data acquired by the family-data acquisition section and the transaction data acquired by the transaction-data acquisition section, and the control section selects an advertisement data item.

17. An apparatus according to claim 16, further comprising an inventory-data acquisition section which acquires inventory data concerning items transacted in the shop, and in which the control section generates purchase data concerning items to be purchased into the shop, in accordance with the inventory data and at least one of data items representing the items to be transacted by the customer, the number of pieces of each item to be transacted and the shop in which the items are to be transacted, and sends the purchase data to the shop.

18. An apparatus according to claim 15, wherein the control section collates the advertisement data sent to the customer with the data representing the items transacted and acquired by the transaction-data acquisition section after the advertisement data is sent to the customer, thereby to determine whether a transaction has been made on the basis of the advertisement data, and corrects a condition for selecting the advertisement data.

19. An apparatus for processing advertisement data, comprising:
an advertisement data storage section which stores advertisement data concerning transactions made by the customer in a shop;
a transaction-data acquisition section which acquires transaction data containing transaction-item data representing the items transacted by the customer, quantity data representing the number of pieces of each item transacted and charge data representing the charge for the items transacted;
a transaction-content calculating section which calculates the number of pieces of each item transacted, the types of the items transacted and charges for each item transacted, in accordance with the transaction data about the transactions that the customer has made in a predetermined period, and which generates transaction-number data, item-number data and total charge data;
a family-data determining section which generates family data about the customer's family, in accordance with the transaction-number data, the item-number data and the total charge data; and
a control section which selects advertisement data items in accordance with the family data and at least one of the transaction-number data, the item-number data and the total charge data, and which sends the advertisement data items to the customer.

20. An apparatus according to claim 19, wherein
the advertisement data contains data items representing items advertised and data items representing charges for the items, and
the control section calculates, in accordance with the transaction data, the number of pieces of each item transacted in the predetermined period and selects an advertisement data item about the item that has been transacted in a quantity greater than a preset value.

21. An apparatus according to claim 19, further comprising an inventory-data acquisition section which acquires inventory data concerning items transacted in the shop, and in which the control section generates purchase data concerning items to be purchased into the shop, in accordance with the inventory data and the transaction-number data, item-number data and total charge data generated by the transaction-content calculating section, and sends the purchase data to the shop.

22. A system for processing advertisement data comprising:
an advertisement-data processing apparatus as defined in claim 14; and
a customer terminal which is owned by a customer and connected to the advertisement-data processing apparatus to transmit and receive various data items to and from the advertisement-data processing apparatus.

23. A system for processing advertisement data comprising:
an advertisement-data processing apparatus as defined in claim 19; and
a customer terminal which is owned by a customer and connected to the advertisement-data processing apparatus to transmit and receive various data items to and from the advertisement-data processing apparatus.

24. A system according to claim 22, further comprising a shop terminal which is owned by a shop and connected to the advertisement-data processing apparatus to transmit and receive various data items to and from the advertisement-data processing apparatus.

25. A system according to claim 23, further comprising a shop terminal which is owned by a shop and connected to the advertisement-data processing apparatus to transmit and receive various data items to and from the advertisement-data processing apparatus.

26. A system according to claim 24, wherein the shop terminal is connected to the customer terminal to transmit and receive various data items to and from the customer terminal.

27. A system according to claim 25, wherein the shop terminal is connected to the customer terminal to transmit and receive various data items to and from the customer terminal.

28. A method of processing advertisement data concerning the transactions made by a customer, by using an operation section, said method comprising:
acquiring family data about the customer's family and calculating the total charge for transactions that the customer has made in a shop in a predetermined period, thereby to generate total charge data; and
selecting advertisement data items for the customer from the advertisement data stored in an advertisement data storage section, in accordance with the family data and the total charge data, and sending the advertisement data items to the customer.

29. A method of processing advertisement data concerning the transactions made by a customer, by using an operation section, said method comprising:
acquiring, for a predetermined period, transaction data containing transaction-item data representing the items transacted by the customer, quantity data representing the number of pieces of each item transacted and charge data representing the charge for the items transacted;
calculating the number of pieces of each item transacted, the types of the items transacted and charges for each item transacted, in accordance with the transaction data about the transactions that the customer has made in a predetermined period, and generating transaction-number data, item-number data and total charge data;
determining family data about the customer's family, in accordance with the transaction-number data, the item-number data and the total charge data; and
selecting advertisement data items for the customer from an advertisement data storage section in accordance with the family data and at least one of the transaction-number data, the item-number data and the total charge data, and sending the advertisement data items to the customer.

30. A data-determining program for causing an operation section to perform the data-determining method as defined in claim 12.

31. A data-determining program for causing an operation section to perform the data-determining method as defined in claim 13.

32. A recording medium recording the data-determining program as defined in claim 30, which is readable by an operation section.

33. A recording medium recording the data-determining program as defined in claim 31, which is readable by an operation section.

34. A program for processing advertisement data, for causing an operation section to perform the advertisement-data processing method as defined in claim 28.

35. A program for processing advertisement data, for causing an operation section to perform the advertisement-data processing method as defined in claim 29.

36. A recording medium recording the advertisement-data processing program as defined in claim 34, which is readable by an operation section.

37. A recording medium recording the advertisement-data processing program as defined in claim 35, which is readable by an operation section.
